(19) United States
(12) Patent Application Publication
(10) Pub. No.: US 2024/0012856 A1
(43) Pub. Date: Jan. 11, 2024

(54) METHOD AND SYSTEM THAT ACCOUNTS FOR APPEARANCE CHANGES IN AN OBJECT THAT ARE ATTRIBUTABLE TO OBJECT DEFORMATION OR RESTORATION

(71) Applicant: MOTOROLA SOLUTIONS, INC., CHICAGO, IL (US)

(72) Inventors: MIROSLAW KAWA, Kryspinow (PL); KONRAD HEKSEL, CZERNICHOW (PL); KRZYSZTOF MINIOR, RUDAWA (PL); MIKOLAJ KARWAT, WIELICZKA (PL)

(21) Appl. No.: 17/811,358

(22) Filed: Jul. 8, 2022

(51) Int. Cl. G06F 16/783; G06F 3/04847; G06F 16/78

(52) U.S. Cl. CPC G06F 16/7837; G06F 3/04847; G06F 16/7867

(57) ABSTRACT

A method and system that accounts for appearance changes in an object, attributable to object deformation or restoration, is disclosed. The system includes an object deformation prediction database. The object deformation prediction database is accessible as a function of the type of the object. The object deformation prediction database can identify one or more ways in which the type of object, and thus the object, is deformable to or restorable from a reference appearance that is depicted in a particular sub-region of an object.

### BACKGROUND

In environments where video or image management systems are employed, it is common to want to find when a particular object has appeared in the field of view of various cameras. It can be hugely time consuming to manually review large quantities of images and/or video footage to find all instances of this particular object, so systems such as, for example, Artificial Intelligence (AI)-powered Avigilon Appearance Search™ have been developed to automate the process. When there is a significant change in the appearance of an object over time, the video or image management system needs to have ways to adjust its searching so that retrieval of appearance instances are not missed due to the significant change.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a video system in accordance with example embodiments.

FIG. 2 is a flow chart illustrating a method in accordance with an example embodiment.

FIG. 3 is a diagram depicting a Graphical User Interface (GUI) region within which is shown a reference image of an object.

FIG. 4 is a diagram depicting another GUI region within which is shown another image of the object of FIG. 3.

FIG. 5 is a diagram depicting a redacted image of the object of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

According to one example embodiment, there is provided a computer-implemented method that includes receiving, at a computer terminal, user input identifying a particular sub-region of an object appearing within a region of first video. The computer-implemented method also includes determining, by an at least one processor and responsively to the user input, a type of the object. The computer-implemented method also includes accessing, by the at least one processor, an object deformation prediction database as a function of the type of the object. The object deformation prediction database identifies one or more ways in which the type of the object, and thus the object, is deformable to or restorable from a reference appearance that is depicted in the particular sub-region. The computer-implemented method also includes accessing or receiving, at the computer terminal, at least one of additional images and additional video depicting a respective plurality of objects that potentially match the object appearing in the first video based on a similarity determination which factors in identified one or more ways in which the particular sub-region of the object is deformable to or restorable from the reference appearance. The computer-implemented method also includes presenting at least one of: i) video clips from the additional video; and ii) the additional images, within a user interface configured to facilitate user interaction to confirm or reject at least one of the potential matching objects as a match to the object or a non-match to the object, respectively.

According to another example embodiment, there is provided a system that includes an object deformation prediction database and an at least one processor communicatively coupled to the object deformation prediction database. The at least one processor is configured to determine, responsive to received user input identifying a particular sub-region of an object appearing within a region of first video, a type of the object. The at least one processor is also configured to access the object deformation prediction database as a function of the type of the object. The object deformation prediction database identifies one or more ways in which the type of object, and thus the object, is deformable to or restorable from a reference appearance that is depicted in the particular sub-region. A computer terminal is operatively associated with the at least one processor. The computer terminal includes a display and is configured to access or receive at least one of additional images and additional video depicting a respective plurality of objects that potentially match the object appearing in the first video based on a similarity determination which factors in identified one or more ways in which the particular sub-region of the object is deformable to or restorable from the reference appearance. At least one of: i) video clips from the additional video; and ii) the additional images are presentable on the display and within a user interface. The user interface is configured to facilitate user interaction to confirm or reject at least one of the potential matching objects as a match to the object or a non-match to the object, respectively.

Each of the above-mentioned embodiments will be discussed in more detail below, starting with example system and device architectures of the system in which the embodiments may be practiced, followed by an illustration of processing blocks for achieving an improved technical method, system and computer program product for smart video and/or image searching and retrieval. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

The term “object” as used herein is understood to have the same meaning as would normally be given by one skilled in the art of video/image analytics, and examples of objects may include moving objects such as, for instance, humans, faces, vehicles, license plates attached to vehicles, animals, etcetera. Examples of objects also include static objects such as, for instance, buildings, roads, signs attached to buildings or other fixed-location structures, fixtures, etcetera.

Further advantages and features consistent with this disclosure will be set forth in the following detailed description, with reference to the figures.

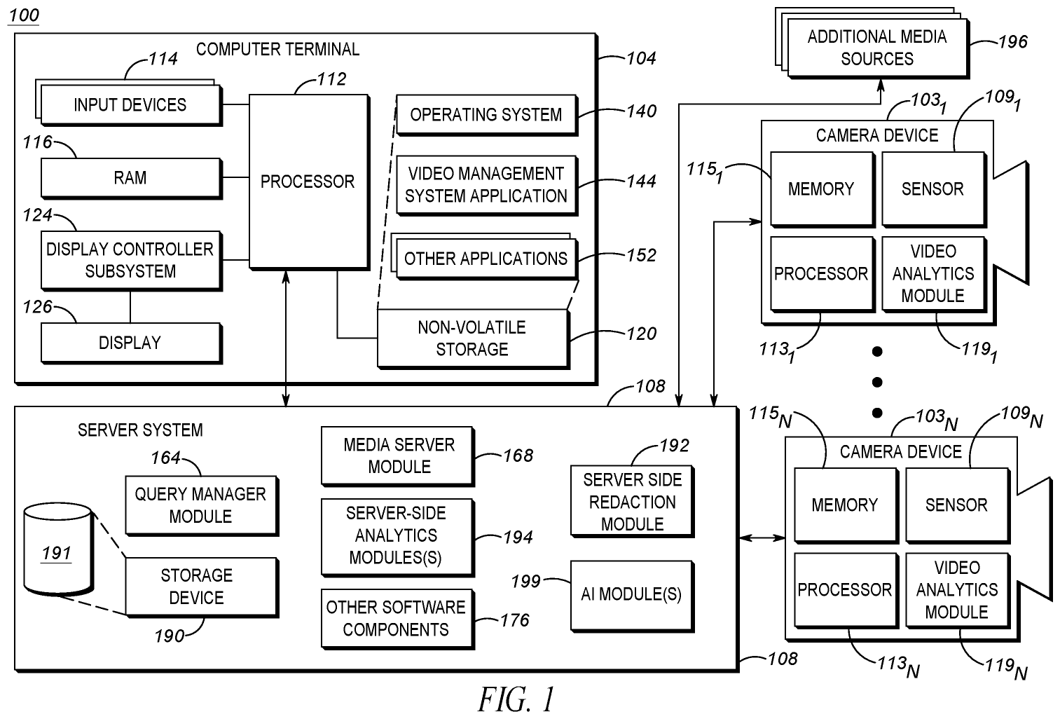

Referring now to the drawings, and in particular FIG. 1 which is a block diagram of an example video system 100 within which methods in accordance with example embodiments can be carried out. Included within the illustrated video system 100 are one or more computer terminals 104 and a server system 108. In some example embodiments, the computer terminal 104 is a personal computer system; however in other example embodiments the computer terminal 104 is a selected one or more of the following: a handheld device such as, for example, a tablet, a phablet, a smart phone or a personal digital assistant (PDA); a laptop computer; a smart television; and other suitable devices. With respect to the server system 108, this could comprise a single physical machine or multiple physical machines. It will be understood that the server system 108 need not be contained within a single chassis, nor necessarily will there be a single location for the server system 108. As will be appreciated by those skilled in the art, at least some of the functionality of the server system 108 can be implemented within the computer terminal 104 rather than within the server system 108. In some examples, part or all of the server system 108 is provided within the video system 100 by way of a cloud computing implementation.

The computer terminal 104 communicates with the server system 108 through one or more networks. These networks can include the Internet, or one or more other public/private networks coupled together by network switches or other communication elements. The network(s) could be of the form of, for example, client-server networks, peer-to-peer networks, etc. Data connections between the computer terminal 104 and the server system 108 can be any number of known arrangements for accessing a data communications network, such as, for example, dial-up Serial Line Interface Protocol/Point-to-Point Protocol (SLIP/PPP), Integrated Services Digital Network (ISDN), dedicated lease line service, broadband (e.g. cable) access, Digital Subscriber Line (DSL), Asynchronous Transfer Mode (ATM), Frame Relay, or other known access techniques (for example, radio frequency (RF) links). In at least one example embodiment, the computer terminal 104 and the server system 108 are within the same Local Area Network (LAN).

The computer terminal 104 includes at least one processor 112 that controls the overall operation of the computer terminal. The processor 112 interacts with various subsystems such as, for example, input devices 114 (such as a selected one or more of a keyboard, mouse, touch pad, roller ball and voice control means, for example), random access memory (RAM) 116, non-volatile storage 120, display controller subsystem 124 and other subsystems. The display controller subsystem 124 interacts with display 126 and it renders graphics and/or text upon the display 126.

Still with reference to the computer terminal 104 of the video system 100, operating system 140 and various software applications used by the processor 112 are stored in the non-volatile storage 120. The non-volatile storage 120 is, for example, one or more hard disks, solid state drives, or some other suitable form of computer readable medium that retains recorded information after the computer terminal 104 is turned off. Regarding the operating system 140, this includes software that manages computer hardware and software resources of the computer terminal 104 and provides common services for computer programs. Also, those skilled in the art will appreciate that the operating system 140, Video Management System (VMS) application 144, and other applications 152, or parts thereof, may be temporarily loaded into a volatile store such as the RAM 116. The processor 112, in addition to its operating system functions, can enable execution of the various software applications on the computer terminal 104.

Regarding the VMS application 144, this can be run on the computer terminal 104 and may include a search User Interface (UI) module for cooperation with a search session manager module in order to enable a computer terminal user to carry out actions related to providing input in relation images, live video and video recordings (such as, for example, input to facilitate any one or more of annotating, redacting or selectively exporting video footage captured by one or more video security cameras, providing responses to automatically generated security alerts, appearance searching, etcetera). Also, regarding the aforementioned search session manager module, this provides a communications interface between the search UI module and a query manager module 164 of the server system 108. In at least some examples, the search session manager module communicates with the query manager module 164 through the use of Remote Procedure Calls (RPCs). The query manager module 164 receives and processes queries originating from the computer terminal 104, which may facilitate retrieval and delivery of various sorts of data and metadata (such as, for instance, recorded video, video metadata, etcetera). In this regard, the query manager module 164 is communicatively coupled to an at least one storage device 190 (described later herein in more detail).

Referring once again to FIG. 1, the server system 108 includes several software components (besides the query manager module 164 already described) for carrying out other functions of the server system 108. For example, the server system 108 includes a media server module 168. The media server module 168 handles client requests related to storage and retrieval of security video taken by camera devices 103₁-103ₙ, in the video system 100. In some examples, the media server module 168 may carry out other functions in relation to other forms of media communicated to the computer terminal 104 from the server system 108 (for example, facilitating the delivery of live or recorded video to the VMS application 144 to be viewed on the display 126 of the computer terminal 104). The server system 108 also includes server-side analytics module(s) 194 which can include, in some examples, any suitable one of known commercially available software that carry out computer vision related functions (complementary to any video/image analytics performed in the cameras) as understood by a person of skill in the art. The server system 108 also includes a server-side redaction module 192 (described later herein in more detail).

The server system 108 also includes a number of other software components 176. These other software components will vary depending on the requirements of the server system 108 within the overall system. As just one example, the other software components 176 might include special test and debugging software, or software to facilitate version updating of modules within the server system 108.

Regarding the at least one storage device 190, this comprises, for example, one or more databases 191 which may facilitate the organized storing of recorded security video in accordance with example embodiments. The one or more databases 191 may also contain metadata related to, for example, the recorded video (and/or image) storable within one or more storages. The one or more databases 191 may also contain other types of metadata besides video metadata. Examples of metadata other than video/image metadata, that may be stored in the one or more databases 191, include audio metadata, Global Positioning System (GPS) location metadata, etcetera.

The illustrated video system 100 includes a plurality of camera devices 103₁-103ₙ, (hereinafter interchangeably referred to as “cameras 103₁-103ₙ” when referring to all of the illustrated cameras, or “camera 103” when referring to any individual one of the plurality) being operable to capture a plurality of images and produce image data representing the plurality of captured images. The camera 103 is an image capturing device and includes security video cameras. Furthermore, it will be understood that the video system 100 includes any suitable number of cameras (i.e. n is any suitable integer greater than one).

The camera 103 includes an image sensor 109 for capturing a plurality of images. The camera 103 may be a digital camera and the image sensor 109 may output captured light as a digital data. For example, the image sensor 109 may be a CMOS, NMOS, or Charge-Couple Device (CCD). In some embodiments, the camera 103 may be an analog camera connected to an encoder. The illustrated camera 103 may be a 2D camera; however use of a structured light 3D camera, a time-of-flight 3D camera, a 3D Light Detection and Ranging (LiDAR) device, a stereo camera, or any other suitable type of camera within the video system 100 is contemplated.

The image sensor 109 may be operable to capture light in one or more frequency ranges. For example, the image sensor 109 may be operable to capture light in a range that substantially corresponds to the visible light frequency range. In other examples, the image sensor 109 may be operable to capture light outside the visible light range, such as in the infrared and/or ultraviolet range. In other examples, the camera 103 may have similarities to a “multi-sensor” type of camera, such that the camera 103 includes pairs of two or more sensors that are operable to capture light in different and/or same frequency ranges.

The camera 103 may be a dedicated camera. It will be understood that a dedicated camera herein refers to a camera whose principal features is to capture images or video. In some example embodiments, the dedicated camera may perform functions associated with the captured images or video, such as but not limited to processing the image data produced by it or by another camera. For example, the dedicated camera may be a security camera, such as any one of a pan-tilt-zoom camera, dome camera, in-ceiling camera, box camera, and bullet camera.

Additionally, or alternatively, the camera 103 may include an embedded camera. It will be understood that an embedded camera herein refers to a camera that is embedded within a device that is operational to perform functions that are unrelated to the captured image or video. For example, the embedded camera may be a camera found on any one of a laptop, tablet, drone device, smartphone, physical access control device, video game console or controller.

The camera 103 includes one or more processors 113, one or more video analytics modules 119, and one or more memory devices 115 coupled to the processors and one or more network interfaces. Regarding the video analytics module 119, this generates metadata outputted to the server system 108. The metadata can include, for example, records which describe various detections of objects such as, for instance, pixel locations for a detected moving object in respect of a first record and a last record for the camera within which the respective metadata is being generated.

Regarding the memory device 115 within the camera 103, this can include a local memory (such as, for example, a random access memory and a cache memory) employed during execution of program instructions. Regarding the processor 113, this executes computer program instructions (such as, for example, an operating system and/or software programs), which can be stored in the memory device 115.

In various embodiments the processor 113 may be implemented by any suitable processing circuit having one or more circuit units, including a digital signal processor (DSP), graphics processing unit (GPU) embedded processor, a visual processing unit or a vison processing unit (operating optionally in combination with an artificial intelligence image signal processor), etcetera, and any suitable combination thereof operating independently or in parallel, including possibly operating redundantly. Such processing circuit may be implemented by one or more integrated circuits (IC), including being implemented by a monolithic integrated circuit (MIC), an Application Specific Integrated Circuit (ASIC), a Field Programmable Gate Array (FPGA), etc. or any suitable combination thereof. Additionally or alternatively, such processing circuit may be implemented as a programmable logic controller (PLC), for example. The processor may include circuitry for storing memory, such as digital data, and may comprise the memory circuit or be in wired communication with the memory circuit, for example. A system on a chip (SOC) implementation is also common, where a plurality of the components of the camera 103, including the processor 113, may be combined together on one semiconductor chip. For example, the processor 113, the memory device 115 and the network interface of the camera 103 may be implemented within a SOC. Furthermore, when implemented in this way, a general purpose processor and one or more of a GPU or VPU, and a DSP may be implemented together within the SOC.

In various example embodiments, the memory device 115 coupled to the processor 113 is operable to store data and computer program instructions. The memory device 115 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory device 115 may be operable to store in memory (including store in volatile memory, non-volatile memory, dynamic memory, etc. or any combination thereof).

Continuing with FIG. 1, the camera 103 is coupled to the server system 108. In some examples, the camera 103 is coupled to the server system 108 via one or more suitable networks. These networks can include the Internet, or one or more other public/private networks coupled together by network switches or other communication elements. The network(s) could be of the form of, for example, client-server networks, peer-to-peer networks, etc. Data connections between the camera 103 and the server system 108 can be any number of known arrangements, examples of which were previously herein detailed. In at least one example embodiment, the camera 103 and the server system 108 are within the same Local Area Network (LAN).

The one or more additional media sources 196 may be external or internal to the illustrated video system 100. The additional media sources 196 may include storage devices that store various types of video and image data (which may exist in combination with or in alternative to any video and image data stored in the storage device 190). In some examples, the additional media sources 196 may be in the cloud and/or located in third party systems, auxiliary systems, etc.

In some examples, the additional media sources 196 are coupled to the server system 108 via one or more suitable networks. These networks can include the Internet, or one or more other public/private networks coupled together by network switches or other communication elements. The network(s) could be of the form of, for example, client-server networks, peer-to-peer networks, etc. Data connections between the additional media sources 196 and the server system 108 can be any number of known arrangements, examples of which were previously herein detailed. In some examples, the additional media sources 196 may be coupled to the server system 108 in a more direct manner than as described above.

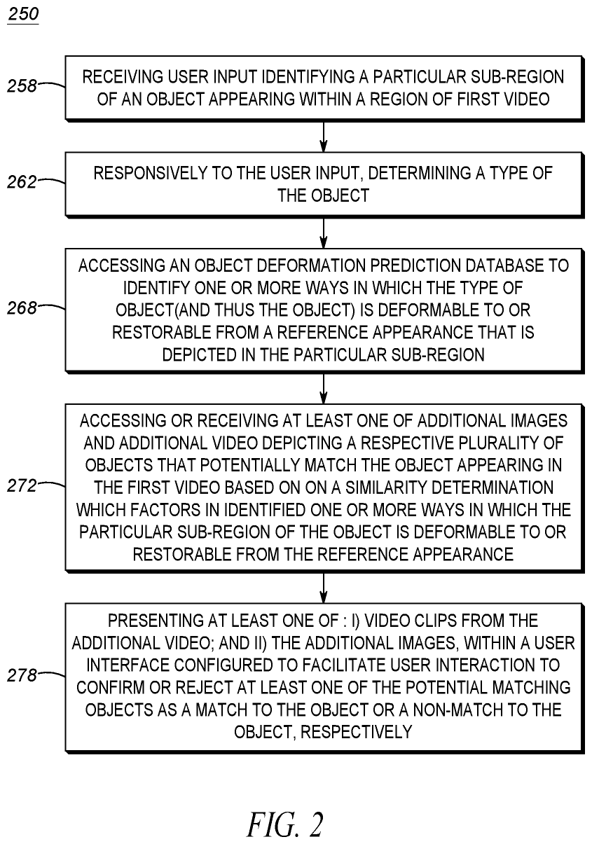

Reference is now made to FIG. 2. In particular, FIG. 2 is a flow chart illustrating a method 250 in accordance with an example embodiment, which in some examples is carried out within the video system 100.

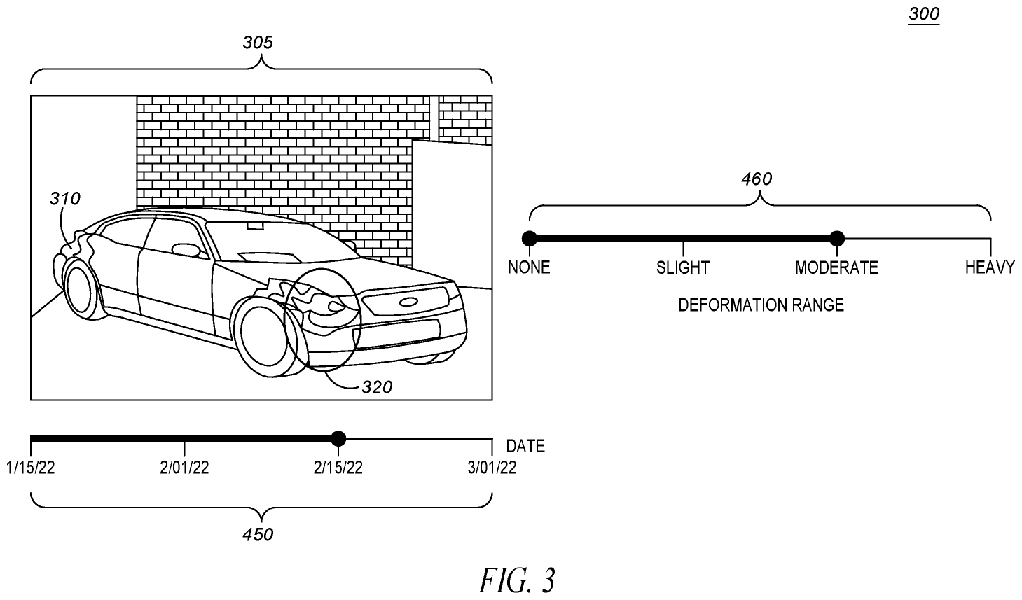

The illustrated method 250 firstly includes receiving (258) user input identifying a particular sub-region of an object appearing within a region of first video. For example, the user input may be received via the computer terminal 104. More specifically, a user may interact with one or more of the input devices 114 to provide input via, for instance, some Graphical User Interface (GUI) forming part of the VMS application 144 of the computer terminal 104. Further possible example details in relation to the action 258 may be seen from FIG. 3. In particular, FIG. 3 is a diagram depicting a GUI region 300, and showing a reference image 305 of an object 310 (which in the illustrated example is a vehicle), a sub-region (i.e. front-right of vehicle) of which has been user-identified by overlayed positioning of a selector tool 320. In some examples, additional input (supplemental) to the above-described user input is contemplated. For instance, reference image data that originated from image sensors that capture light outside the visible light range may also inform searching. As one example, those skilled in the art will appreciate that ultraviolet light imagers can be used to show detail of damage to a vehicle that may not be visible within the spectrum range of visible light.

Regarding the above-mentioned user input to identify a particular sub-region of an object, this may be manual user input; however user input that includes one or more computer assisted elements is also contemplated. For example, the user input may be electronically derived from or electronically compared to deformation-detailing records stored in another database (for example, a database forming a part of the additional media sources 196). In some examples, these deformation-detailing records may include at least one of video metadata records, police report records, hospital report records and insurance report records.

Next the method 250 includes determining (262) a type of the object, which is carried out responsively to the user input. For instance, after the user has provided some initial search parameters (including identification of the object sub-region as described above), an at least one processor may analyze the reference image to determine the type of the object. In some examples, the action 262 may be carried out within the server system 108 facilitated at least in part by the AI module(s) 199 (i.e. AI-based object recognition may be carried out within the server system 108). The determination of the type of the object may be a general determination such as, for example, “car”; however alternatively the determination of the type of the object may be a more specific determination such as, for example, a determination that the object is a car of a specific year, make and model.

Next the method 250 includes accessing (268) an object deformation prediction database as a function of the type of the object. In some examples, the object deformation prediction database forms part of the one or more databases 191 shown in FIG. 1. The object deformation prediction database identifies one or more ways in which the type of object, and thus the object, is deformable to or restorable from a reference appearance that is depicted in the particular sub-region that was identified during the action 258. It will be understood that different objects will be deformed (or restored) differently. For instance, vehicles typically include metal and glass, each of which breaks differently upon damaging impact than, for example, bricks of a building when they have received damaging impact. In some examples, the object deformation prediction database may include an object deformation machine learning prediction model as will be understood by those skilled in the art.

Next the method 250 includes accessing or receiving (272) at least one of additional images and additional video depicting a respective plurality of objects that potentially match the object appearing in the first video based on a similarity determination which factors in identified one or more ways in which the particular sub-region of the object is deformable to or restorable from the reference appearance. In some examples, the accessing or receiving of the at least one of additional images and additional video may occur at the computer terminal 104 and/or the server system 108.

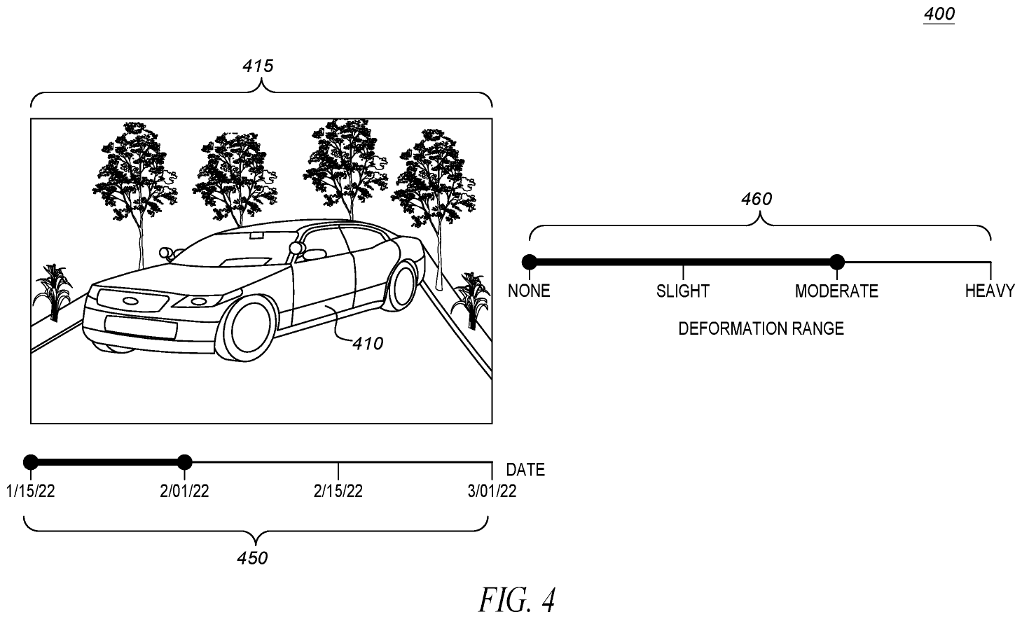

Next the method 250 includes presenting (278) at least one of: i) video clips from the additional video; and ii) the additional images, within a user interface configured to facilitate user interaction to confirm or reject at least one of the potential matching objects as a match to the object or a non-match to the object, respectively. In terms of an illustrative example in this regard, reference is made to FIG. 4, which diagrammatically illustrated a GUI region 400. In FIG. 4, a vehicle 410 is shown within image 415. The image may, for instance, be displayed on the display 126 of the computer terminal 104 (FIG. 1).

In some examples, a user may interact with the GUI region 400 to confirm or reject the vehicle 410 as a match to the object shown in reference image 305 (FIG. 3).

As mentioned, the GUI regions 300 and 400 may be generated by a GUI of the VMS application 144. Besides the description already provided, a first user interface slider 450 and a second user interface slider 460 are shown in both FIGS. 3 and 4.

Regarding the first user interface slider 450, this is provided to enable interactive scrubbing within chronological time periods corresponding to a plurality of images and/or video portions (for example, a plurality of video clips and/or time-stamped images within which there are respective appearances of a common object-of-interest being investigated).

Regarding the second user interface slider 460, this is provided for interactive adjustment to change a maximum level for a deformation range, where the previously herein described identifying by the object deformation prediction database is limited to carrying out identifying within the deformation range. More broadly, some examples may provide a user modifiable deformation limit parameter that sets a maximum level for a deformation range.

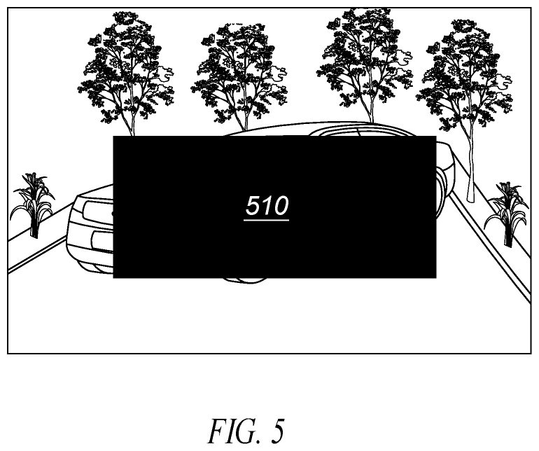

Reference is now made to FIG. 5. FIG. 5 is a diagram depicting a redacted image of the object of FIGS. 3 and 4. In particular, redaction 510 is applied over the object. This may be carried out by, for instance, the server-side redaction module 192 (FIG. 1). In accordance with some examples, once one or more video clips have been assembled (for instance, for export) redactions can be applied to one or more of the matching objects in the respective once one or more video clips.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etcetera, and cannot process metadata to find matching images and/or video clips for presentation on a display, among other features and functions set forth herein).

In the foregoing specification, specific embodiments have been described. However, one of ordinary skill in the art appreciates that various modifications and changes can be made without departing from the scope of the invention as set forth in the claims below. For example, instead of the object being a vehicle, other objects like store/house fronts, people, etcetera are also contemplated. In the case of a store front or a house front, the object deformation prediction database may provide a number of indications of one or more ways that the store front or the house front is deformable due to an accident, explosion, etcetera. In the case of a person, the object deformation prediction database may provide a number of indications of one or more ways that the exterior body of the person is deformable due to a physical injury.

Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method comprising:
receiving, at a computer terminal, user input identifying a particular sub-region of an object appearing within a region of first video;
determining, by an at least one processor and responsively to the user input, a type of the object;
accessing, by the at least one processor, an object deformation prediction database as a function of the type of the object, the object deformation prediction database identifying one or more ways in which the type of the object, and thus the object, is deformable to or restorable from a reference appearance that is depicted in the particular sub-region;
accessing or receiving, at the computer terminal, at least one of additional images and additional video depicting a respective plurality of objects that potentially match the object appearing in the first video based on a similarity determination which factors in identified one or more ways in which the particular sub-region of the object is deformable to or restorable from the reference appearance; and
presenting at least one of: i) video clips from the additional video; and ii) the additional images, within a user interface configured to facilitate user interaction to confirm or reject at least one of the potential matching objects as a match to the object or a non-match to the object, respectively.

2. The method of claim 1 wherein the object deformation prediction database includes an object deformation machine learning prediction model.

3. The method of claim 1 further comprising:
receiving, by the at least one processor, confirming input that the at least one of the potential matching objects matches the object; and
redacting, by the at least one processor, the at least one of the potential matching objects from one or more of the video clips.

4. The method of claim 1 further comprising receiving at least one value for a user modifiable deformation limit parameter that sets a maximum level for a deformation range, and
wherein the identifying by the object deformation prediction database is limited to carrying out identifying within the deformation range.

5. The method of claim 4 further comprising generating a user interface slider on a display of the computer terminal, and
wherein the user interface slider is configured to be interactively adjusted to change the maximum level.

6. The method of claim 1 further comprising generating a user interface slider on a display of the computer terminal, and
wherein the user interface slider is configured to enable interactive scrubbing within chronological time periods corresponding to the first video and the additional video.

7. The method of claim 1 wherein the user input is electronically derived from or electronically compared to deformation-detailing records stored in another database.

8. The method of claim 7 wherein the deformation-detailing records are comprised of at least one of video metadata records, police report records, hospital report records and insurance report records.

9. The method of claim 1 wherein the object is a vehicle, and the object deformation prediction database provides a number of indications of one or more ways that the vehicle is deformable due to an accident.

10. The method of claim 1 wherein the object is a store front or a house front, and the object deformation prediction database provides a number of indications of one or more ways that the store front or the house front is deformable due to an accident or a hazardous storm or a fire.

11. The method of claim 1 wherein the object is a person, and the object deformation prediction database provides a number of indications of one or more ways that an exterior body of the person is deformable due to a physical injury.

12. A system comprising:
an object deformation prediction database;
at least one processor communicatively coupled to the object deformation prediction database, the at least one processor configured to:
determine, responsive to received user input identifying a particular sub-region of an object appearing within a region of first video, a type of the object, and
access the object deformation prediction database as a function of the type of the object, the object deformation prediction database identifying one or more ways in which the type of object, and thus the object, is deformable to or restorable from a reference appearance that is depicted in the particular sub-region; and
a computer terminal operatively associated with the at least one processor, the computer terminal including a display and configured to:
access or receive at least one of additional images and additional video depicting a respective plurality of objects that potentially match the object appearing in the first video based on a similarity determination which factors in identified one or more ways in which the particular sub-region of the object is deformable to or restorable from the reference appearance, and
present at least one of: i) video clips from the additional video; and ii) the additional images, on the display and within a user interface configured to facilitate user interaction to confirm or reject at least one of the potential matching objects as a match to the object or a non-match to the object, respectively.

13. The system of claim 12 wherein the at least one processor is further configured to:
receive confirming input that the at least one of the potential matching objects matches the object, and
redact the at least one of the potential matching objects from one or more of the video clips.

14. The system of claim 12 wherein the identifying by the object deformation prediction database is limited to carrying out identifying within a deformation range that is set by a user modifiable deformation limit parameter to a maximum level.

15. The system of claim 14 wherein the user interface includes a user interface slider that is configured to be interactively adjusted to change the maximum level.

16. The system of claim 12 wherein the user interface includes a user interface slider that is configured to enable interactive scrubbing within chronological time periods corresponding to the first video and the additional video.

17. The system of claim 12 wherein the object is a vehicle, and the object deformation prediction database is configured to provide a number of indications of one or more ways that the vehicle is deformable due to an accident.

18. The system of claim 12 wherein the object is a store front or a house front, and the object deformation prediction database is configured to provide a number of indications of one or more ways that the store front or the house front is deformable due to an accident or a hazardous storm or a fire.

19. The system of claim 12 wherein the object is a person, and the object deformation prediction database is configured to provide a number of indications of one or more ways that an exterior body of the person is deformable due to a physical injury.
